(19) United States
(12) Patent Application Publication
(10) Pub. No.: US 2026/0195615 A1
(43) Pub. Date: Jul. 9, 2026

(54) LIFELONG KNOWLEDGE UPDATE FOR LARGE LANGUAGE MODELS

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Binchi Zhang, Lawrenceville, NJ (US)

(21) Appl. No.: 19/419,645

(22) Filed: Dec. 15, 2025

Related U.S. Application Data
(60) Provisional application No. 63/742,021, filed on Jan. 6, 2025.
(60) Provisional application No. 63/747,408, filed on Jan. 21, 2025.

(51) Int. Cl. G06N 5/025; G06N 20/00

(52) U.S. Cl. CPC G06N 5/025; G06N 20/00

(57) ABSTRACT

Methods and systems include training codebook parameters to encode knowledge. Parameters of a layer of a pre-trained large language model (LLM) are replaced with the trained codebook parameters. An output is generated using the LLM with the trained codebook parameters, based on an input query.

### RELATED APPLICATION INFORMATION

This application claims priority to U.S. Patent Application No. 63/742,021, filed on Jan. 6, 2025, and to U.S. Patent Application No. 63/747,408, filed on Jan. 21, 2025, each incorporated herein by reference in its entirety.

### BACKGROUND

### Technical Field

The present invention relates to large language models (LLMs) and, more particularly, to updating LLM knowledge.

### Description of the Related Art

LLMs are remarkably successful at natural language processing tasks and can encode a large amount of knowledge, but their utility relies on timely updates as human knowledge evolves. Existing approaches attempt to unlearn outdated information and to learn new information, but encounter task conflicts and knowledge management issues when applied to comprehensive knowledge updates. Such approaches can lead to catastrophic forgetting in long-term learning settings and may overlook conflicts between different knowledge updating tasks. These approaches may further fail to balance between over-fitting and under-fitting with the new knowledge.

### SUMMARY

A method includes training codebook parameters to encode knowledge. Parameters of a layer of a pre-trained large language model (LLM) are replaced with the trained codebook parameters. An output is generated using the LLM with the trained codebook parameters, based on an input query.

A system includes a hardware processor and a memory that stores a computer program. When executed by the hardware processor, the computer program causes the hardware processor to train codebook parameters to encode knowledge, to replace parameters of a layer of a pre-trained LLM with the trained codebook parameters, and to generate an output using the LLM with the trained codebook parameters, based on an input query.

### BRIEF DESCRIPTION OF DRAWINGS

The disclosure will provide details in the following description of preferred embodiments with reference to the following figures wherein:

FIG. 1 is a block diagram illustrating updating knowledge for a large language model (LLM) by replacing parameters of the LLM with parameters from a codebook, in accordance with an embodiment of the present invention;

FIG. 2 is a block/flow diagram of a method for updating knowledge parameters, in accordance with an embodiment of the present invention;

FIG. 3 is a block/flow diagram of a method for a method of performing inference using knowledge from a codebook, in accordance with an embodiment of the present invention;

FIG. 4 is a diagram of a chatbot system where a user can request information from a chatbot that is included in updated knowledge, in accordance with an embodiment of the present invention;

FIG. 5 is a block diagram of a computing device that can perform knowledge updates for a chatbot system, in accordance with an embodiment of the present invention;

FIG. 6 is a diagram of an exemplary neural network architecture that can be used to implement part of an LLM, in accordance with an embodiment of the present invention; and

FIG. 7 is a diagram of an exemplary deep neural network architecture that can be used to implement part of an LLM, in accordance with an embodiment of the present invention.

### DETAILED DESCRIPTION OF PREFERRED EMBODIMENTS

Large language model (LLM) knowledge may be updated through editing and unlearning. For editing tasks, old knowledge and new knowledge sets are used together. For unlearning tasks, a set of unwanted knowledge is provided. Model utility is preserved over the retained knowledge while jointly unlearning unwanted knowledge and modifying old knowledge to new knowledge.

To this end, a knowledge codebook is used to store updated knowledge. Similarity-aware knowledge mapping is used to deliver similar pieces of information to the same knowledge codebook index. Each codebook entry thereby has a knowledge memory that stores a group of similar knowledge pieces. To tackle task-wise conflicts, conflict scores may be determined between tasks, so that task-specific memories may be selected to store grouped knowledge if the conflict score is larger than a conflict threshold. Different types of knowledge memories may be trained separately with task-specific objectives and conflict-aware multi-task objectives. A learning-based relevance threshold may be used to determine whether to use the trained knowledge codebook. If the output value is larger than this relevance threshold, the corresponding knowledge memory may be retrieved.

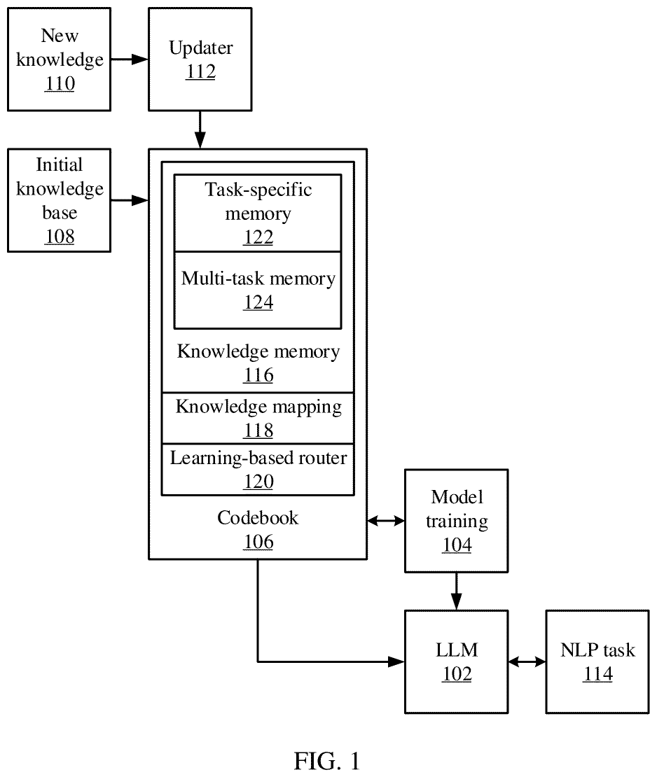

Referring now to FIG. 1, an overview of updating model knowledge is shown. An LLM 102 is trained to perform a natural language processing (NLP) task 114. The NLP task 114 may include any appropriate knowledge-based task, such as question answering or a chatbot. During inference, the NLP task 114 interacts with the LLM 102 by submitting a prompt. The LLM 102 responds by generating an output in accordance with knowledge stored in a codebook 106.

The LLM 102 is trained by model training 104, which makes use of initial knowledge base 108 stored in the codebook 106. The model training 104 trains the LLM 102 to generate its outputs in accordance with whatever information is stored in the codebook 106. After training is complete, new knowledge 110 may be supplied to the codebook 106 through updater 112. During inference, when performing the NLP task 114, the LLM 102 may thereby access the new knowledge 110 as it is encoded in the codebook 106.

The codebook 106 may implement knowledge memory 116, similarity-aware knowledge mapping 118 for allocation and retrieval, and a learning-based router 120 for retrieval. Before implementing the codebook 106, a target layer may be selected from the LLM 102, such as a feedforward network. The parameter matrix of the selected layer is used to initialize the codebook memories.

During model training 104, the parameter matrix of the target layer may be replaced with the knowledge memory 116 that is fine-tuned on the knowledge datasets, while the remaining LLM parameters are kept frozen. During inference, the memories with updated knowledge can be retrieved from the codebook 106 and can be plugged into the LLM 102, enabling efficient knowledge updates without altering the rest of the architecture.

Similarity aware knowledge mapping 118 maps knowledge items to specific knowledge memories, ensuring that related knowledge is grouped and updated cohesively within the same memory. Embeddings of the input knowledge data are extracted using last-token embedding from the preceding layer of the LLM 102. These embeddings are then fed into a clustering model, which organizes related knowledge items into clusters and maps each to a corresponding memory. Knowledge mapping 118 may be instantiated using k-means, which allows for unsupervised processing and ensures balanced and efficient utilization of each knowledge memory. By storing and updating cohesive groups of related knowledge in each memory, the knowledge mapping 118 avoids underfitting.

To further mitigate overfitting, the learning-based router 120 selectively activates the knowledge codebook during inference. The router 120 ensures that the codebook 106 is used only when the input prompt is relevant to the new knowledge 110. Specifically, a text classifier may be used to distinguish relevant inputs from those that are irrelevant. In practice, a pre-trained bidirectional encoder representations from transformers (BERT) classifier may be fine-tuned using positive samples from [symbol] ₁ and [symbol] ᵤ and negative samples from [symbol] ᵣ. The set [symbol] ₗ is a set of information to be learned, the set [symbol] ᵤ is a set of information to be unlearned, and the set [symbol] ᵣ is a set of information to be retained. In particular, the training datasets [symbol] ={ [symbol] }, where [symbol] is the set of inputs and [symbol] is the set of corresponding outputs for the LLM, are split into these three sets.

This fine-tuning process allows the classifier to better capture the semantics of the updated knowledge and effectively generalize to unseen prompts. When performing NLP task 114, the input prompt is passed through the text classifier and the codebook 106 is activated only if the classifier predicts it as being relevant. Considering that irrelevant prompts may outnumber relevant ones, as they fill the complement set of [symbol] ₗ∪ [symbol] ᵤ, a confidence threshold may be used to filter out a larger proportion of irrelevant prompts, as the classifier may naturally exhibit lower confidence for prompts outside its training set [symbol] ₗ∪ [symbol] ᵤ.

To address conflicts between learning and unlearning, knowledge memory 116 may include task-specific knowledge memories 122 to learn new knowledge and unlearn old knowledge separately in cases of heavy conflicts. Specifically, a conflict threshold is compared to a conflict score, which may be calculated as a cosine similarity between task gradients of learning and unlearning. The knowledge memory 116 is fine-tuned using multi-objective optimization for one epoch and the conflicts for each mini-batch are recorded. If the proportion of negative conflict scores exceeds a threshold, a corresponding task-specific memory 122 is deployed. Otherwise a shared multi-task knowledge memory 124 is used.

The conflict score may be determined as a cosine similarity between the gradient of the learning objective and the gradient of the unlearning objective. Task-specific knowledge memories 122 are initialized with the target parameter matrix in the original LLM 102. These memories may then be optimized with the learning objective [symbol] ₗ, the unlearning objective [symbol] ᵤ and the retention objective [symbol] ᵣ:

$${ℒ}_{l} ( {W}_{{l}_{i}} , {𝒟}_{{l}_{i}} ) + {γ}_{r} {ℒ}_{r} ( {W}_{{l}_{i}} , {𝒟}_{r} )$$

$$and$$

$${L}_{u} ( {W}_{{u}_{i}} , {𝒟}_{{u}_{i}} ) + {γ}_{r} {ℒ}_{r} ( {W}_{{u}_{i}} , {𝒟}_{r} )$$

where γᵣ is the weight for regularization term [symbol] ᵣ and i identifies a minibatch. The loss functions include a prediction loss [symbol] ₗ, a negative preference optimization loss [symbol] ᵤ, and a Kullback-Leibler divergence [symbol] ᵣ. The negative preference loss in particular may be expressed as:

$${ℒ}_{u} = \frac{2}{β} {E}_{( x y ) ∼ {𝒟}_{u}} log ( 1 + {( \frac{{P}_{W} ( y \vert x )}{{P}_{{W}_{0}} ( y \vert x )} )}^{β} )$$

where β is a tunable hyperparameter and P_{W} is the model output probability of an answer y given a prompt x. After fine-tuning the task-specific memories 122, the mean knowledge embeddings may be stored as keys for retrieving unlearned and learned memories. During inference, when a task-specific memory is retrieved, the memory with the closest key may be selected as the target memory. For multi-task knowledge memories 124, pareto optimality may be used and the memories may be optimized using multiple gradient descent.

Model providers in practical scenarios may receive knowledge update requests sequentially, where each request may include a knowledge dataset for the update. To accommodate this continuous evolution, a dynamic codebook architecture stores updated knowledge of each request in the codebook 106 alongside the original model. When processing the k^{th} update request, a classifier is trained using the cumulative datasets from all k updates. At inference time, this classifier determines which codebook (if any) should be activated for a given input, enabling seamless access to the appropriate knowledge version. This design ensures that ongoing knowledge updates can be handled without retraining the entire system, all while maintaining isolation between different updates.

The classifier may be implemented by fine-tuning a pre-trained BERT model. The fine-tuning may use positive examples from [symbol] ₗ and [symbol] ᵤ and negative examples from [symbol] ᵣ. If the classifier outputs a positive prediction, the input is identified as being relevant to the updated knowledge. Otherwise the input is identified as being irrelevant. A confidence threshold may be used, where the decision boundary of the classifier may be tuned as a hyperparameter to filter out low-confidence cases, which are likely to be irrelevant to the updated knowledge.

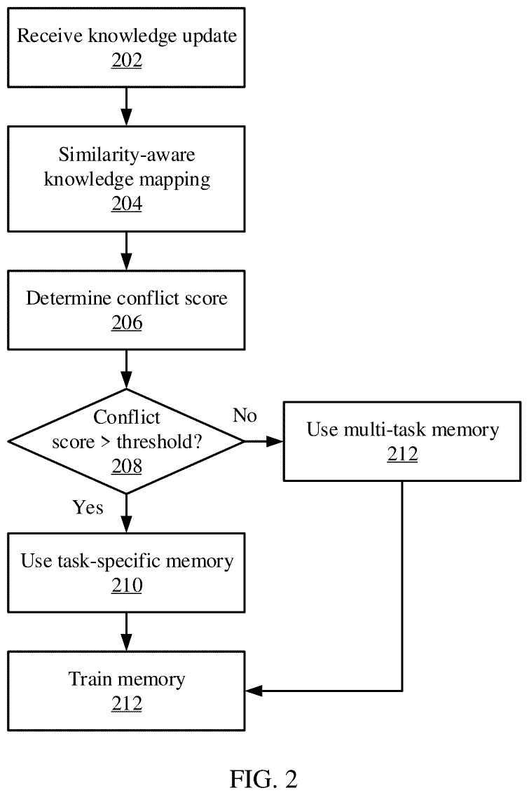

Referring now to FIG. 2, a method for updating a codebook 106 is shown. Block 202 receives a knowledge update, for example including a dataset of information that is new, incorrect, or needs to be changed. Block 204 performs similarity-aware knowledge mapping, for example embedding input the knowledge update using last-token embedding from the preceding LLM layer. Knowledge mapping may be instantiated as a clustering model, for example using K-means. The clustering model may be trained on a combination of [symbol] ₗ and [symbol] ᵤ to obtain clusters of knowledge items to be updated separately. After training, the clustering model is able to map input knowledge to its closest cluster of updated knowledge.

Block 206 determines a conflict score for the knowledge update, for example as the cosine similarity between task gradients of learning and unlearning. The gradients used to compute the conflict score come directly from the training process. During each minibatch, a gradient is computed of the editing objective Lₑ, which is the cross-entropy loss over the new-knowledge dataset Dₑ, and the gradient of the unlearning objective Lᵤ, which is the gradient-ascent loss applied to the unlearning dataset Dᵤ. These two gradients, ∇Lₑ and ∇Lᵤ, are obtained by inserting the knowledge memory into the target LLM layer, freezing the rest of the model, running forward and backward passes on the corresponding minibatch, and extracting the resulting parameter gradients. The layer of the LLM that is selected for knowledge update may be treated as a hyperparameter, that may be tuned for best results. In practice, this layer tends to be a layer that is mid-to-late in the sequence of layers of the LLM. The conflict score is computed as the cosine similarity between these two gradients.

Block 208 then compares the conflict score to a conflict threshold, which may be a tunable hyperparameter. If the level of conflicts for the knowledge is large, a smaller conflict threshold may yield better performance. If the conflict score is greater than the threshold, then block 210 uses a task-specific memory 122. If not, then block 212 uses a multi-task memory 124. Block 212 then uses the updated knowledge to train the selected knowledge memory using gradient descent-based approach. The knowledge memory can be seen as external model parameters, and updating the knowledge memory may be implemented similar to supervised fine-tuning of an LLM.

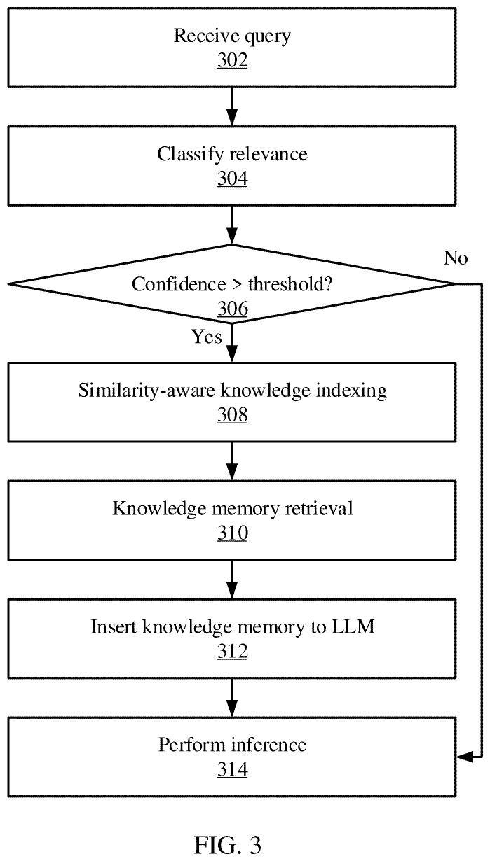

Referring now to FIG. 3, a method of performing inference using the codebook 106 is shown. Block 302 receives a query, such as a natural language prompt, from the NLP task 114. Block 304 classifies the relevance of the query to information stored in the knowledge memory 116. If block 306 determines that the knowledge is relevant, with a confidence greater than a confidence threshold, block 308 performs similarity-aware knowledge mapping to identify knowledge in the knowledge memory 116 to use.

Block 310 retrieves the selected knowledge memory and block 312 inserts that knowledge memory into the LLM 102, for example by replacing parameters of the layer of the LLM 102 with parameters that are stored in the codebook 106. Block 314 then performs inference on the query using the LLM with the inserted parameters. If, in block 306, the confidence was below the confidence threshold, or if the classifier determined that the query was not relevant to the codebook's knowledge at all, then block 314 performs the inference without replacing the layer using codebook information.

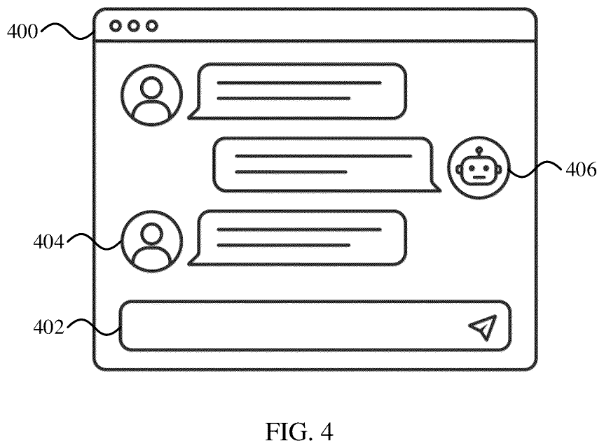

Referring now to FIG. 4, an exemplary chatbot interface 400 is shown. A user may submit queries 404 using an input field 402. The chatbot system may render these queries in any appropriate prompt format and may use them as inputs to the LLM 102. The LLM 102 generates a response, for example using information from the codebook 106, and generates an output 406 that is displayed in the interface 400. In this manner, a user may present questions to the interface 400 and the chatbot system may provide answers based on up-to-date knowledge that is stored in the codebook 106.

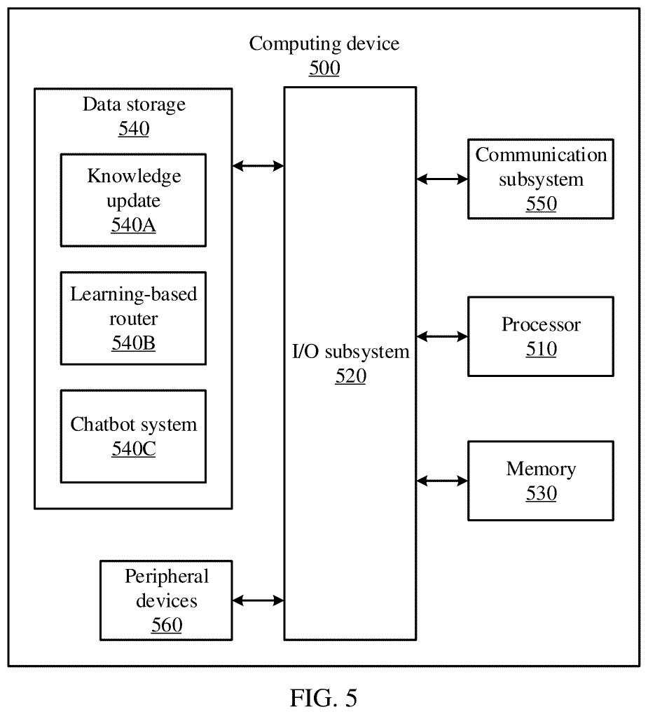

Referring now to FIG. 5, an exemplary computing device 500 is shown, in accordance with an embodiment of the present invention. The computing device 500 is configured to implement an interactive chatbot system.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for updating knowledge in a codebook, 540B for a learning-based router to select knowledge from the codebook, and/or 540C for implementing a chatbot system that uses the codebook knowledge. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

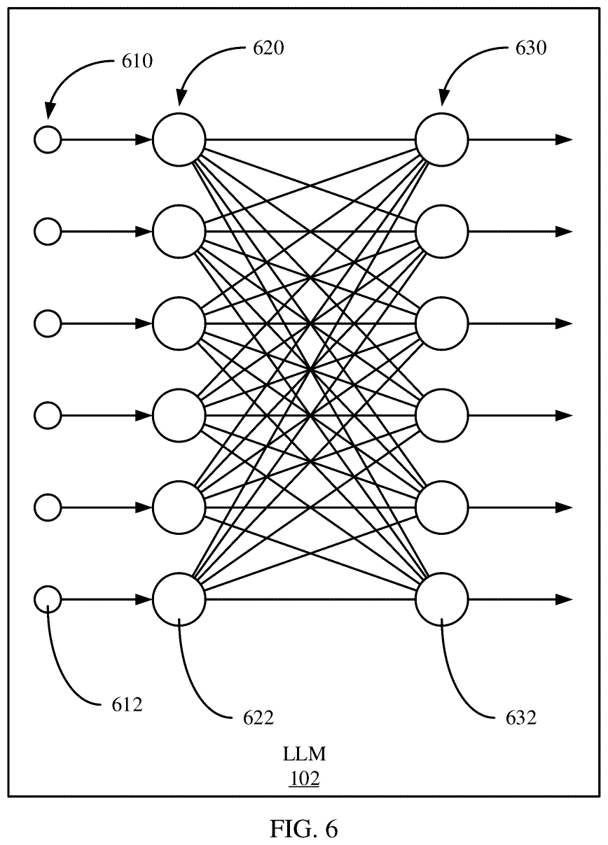

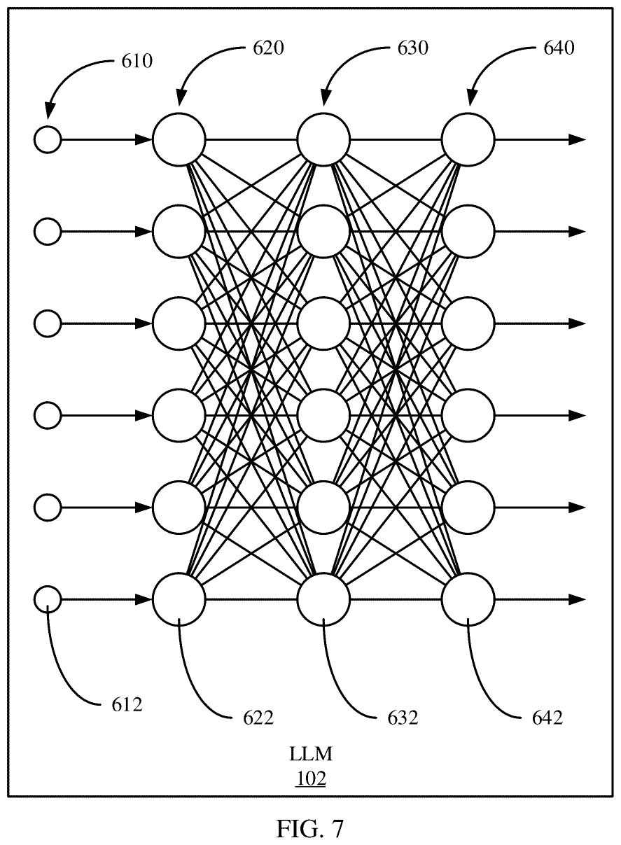

Referring now to FIGS. 6 and 7, exemplary neural network architectures are shown, which may be used to implement parts of the present machine learning models, such as the LLM 102. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
training codebook parameters to encode knowledge;
replacing parameters of a layer of a pre-trained large language model (LLM) with the trained codebook parameters; and
generating an output using the LLM with the trained codebook parameters, based on an input query.

2. The method of claim 1, wherein training the codebook parameters includes training a task-specific memory and a multi-task memory.

3. The method of claim 2, wherein training the codebook parameters further includes determining that a conflict score for the knowledge, based on a plurality of tasks, is greater than a conflict score threshold and updating codebook parameters of the task-specific memory with the knowledge.

4. The method of claim 3, wherein the conflict score is determined as a cosine similarity between a gradient of a learning objective and a gradient of an unlearning objective.

5. The method of claim 4, wherein the unlearning objective is a negative preference optimization loss expressed as:
$${ℒ}_{u} = \frac{2}{β} {E}_{( x , y ) ∼ {𝒟}_{u}} log ( 1 + {( \frac{{P}_{W} ( y \vert x )}{{P}_{{W}_{0}} ( y \vert x )} )}^{β} )$$
where β is a tunable hyperparameter, P_{W} is a model output probability of an answer y given a prompt x, and [symbol] is an expectation value function for the prompt and the answer selected from a dataset of knowledge to be unlearned.

6. The method of claim 1, wherein generating the output includes determining that the query is relevant to the knowledge, with a confidence greater than a confidence threshold.

7. The method of claim 5, further comprising training a classifier to determine relevance of queries to the knowledge.

8. The method of claim 7, wherein the classifier includes a clustering model to identify knowledge similar to the query.

9. The method of claim 1, wherein the input query is received from a user as an input to a chatbot system and wherein the output is displayed to the user by the chatbot system.

10. The method of claim 1, wherein training the parameters includes receiving updated knowledge that includes knowledge to update or unlearn.

11. A system, comprising:
a hardware processor; and
a memory that stores a computer program which, when executed by the hardware processor, causes the hardware processor to:
train codebook parameters to encode knowledge;
replace parameters of a layer of a pre-trained large language model (LLM) with the trained codebook parameters; and
generate an output using the LLM with the trained codebook parameters, based on an input query.

12. The system of claim 11, wherein the training of the codebook parameters includes training of a task-specific memory and a multi-task memory.

13. The system of claim 12, wherein training of the codebook parameters further includes a determination that a conflict score for the knowledge, based on a plurality of tasks, is greater than a conflict score threshold and updating codebook parameters of the task-specific memory with the knowledge.

14. The system of claim 13, wherein the conflict score is determined as a cosine similarity between a gradient of a learning objective and a gradient of an unlearning objective.

15. The system of claim 14, wherein the unlearning objective is a negative preference optimization loss expressed as:
$${ℒ}_{u} = \frac{2}{β} {E}_{( x y ) ∼ {𝒟}_{u}} log ( 1 + {( \frac{{P}_{W} ( y \vert x )}{{P}_{{W}_{0}} ( y \vert x )} )}^{β} )$$
where β is a tunable hyperparameter, P_{W} is a model output probability of an answer y given a prompt x, and [symbol] is an expectation value function for the prompt and the answer selected from a dataset of knowledge to be unlearned.

16. The system of claim 11, wherein generation of output includes determining that the query is relevant to the knowledge, with a confidence greater than a confidence threshold.

17. The system of claim 16, wherein the computer program further causes the hardware processor to train a classifier to determine relevance of queries to the knowledge.

18. The system of claim 17, wherein the classifier includes a clustering model to identify knowledge similar to the query.

19. The system of claim 11, wherein the input query is received from a user as an input to a chatbot system and wherein the output is displayed to the user by the chatbot system.

20. The system of claim 11, wherein training of the parameters includes reception of updated knowledge that includes knowledge to update or unlearn.
